(19) United States
(12) Patent Application Publication
(10) Pub. No.: US 2008/0244077 A1
(43) Pub. Date: Oct. 2, 2008

(54) Methods for auditing peer-to-peer communications in remote device monitoring system and systems thereof

(76) Inventor: John T. Canosa, Spencerport, NY (US)

Correspondence Address: NIXON PEABODY LLP - PATENT GROUP, 1100 CLINTON SQUARE, ROCHESTER, NY, 14604, US

(21) Appl. No.: 12/077,625

(22) Filed: Mar. 20, 2008

Related U.S. Application Data
(60) Provisional application No. 60/919,003, filed on Mar. 20, 2007.

(51) Int. Cl. G06F 15/173

(52) U.S. Cl. 709/227

(57) ABSTRACT

A method, computer readable medium and system for auditing peer-to-peer communications in a remote device monitoring system includes establishing a peer-to-peer communication between at least two computing devices. An auditing system associated with the established peer-to-peer communication is identified and audit information about at least a portion of the established peer-to-peer communication is stored in the identified auditing system.

This application claims the benefit of U.S. Provisional Application No. 60/919,003, filed Mar. 20, 2007, which is hereby incorporated by reference in its entirety.

### FIELD OF THE INVENTION

The present invention generally relates to methods and systems for auditing connections between devices and, more particularly, to methods for auditing peer-to-peer communications in a remote device monitoring system and systems thereof.

### BACKGROUND

Connectivity to remote equipment in the field has become a common practice for many original equipment manufacturers (OEMs). Frequently, this equipment is distributed over a broad geographical region and often involves hundreds, if not thousands or tens of thousands, of individual devices.

Currently, solutions to obtain this connectivity involve the use of a centralized server system between the OEMs and the remote equipment. These solutions require all remote devices to report monitoring and alarm data back to a centralized server system. The collected monitoring and alarm data is only made available to OEMs through monitoring applications running within the centralized server system. Quite often these connectivity and monitoring applications are customized for the particular centralized server system and OEM. As a result, users must learn the particular intricacies of each of these connectivity and monitoring applications before they can become productive.

These solutions also may provide a “data tunneling” capability that allows for the use of existing, OEM developed, diagnostic applications over the Internet through client/server connections, such as telnet and HTTP. Once again, with this data tunneling capability all communications are targeted to a central server system with a specialized switching server that establishes and maintains a connection between the OEM and centralized server system. Since these switching servers are a typical point of failure, switching servers are often clustered to improve performance and availability.

Accordingly, with these existing solutions an OEM can remotely monitor, diagnose, and repair problems with the equipment. As a result, OEMs can be more proactive in preventing and addressing problems with remote equipment before they become serious. Additionally, with these existing OEMs can identify and provide other value added services, such as automatically identifying when remote equipment is or will be in need of replenishment of consumables which can be provided by the OEM. Further, these existing solutions can monitor and audit activities passing through the centralized server system.

Unfortunately, these solutions which utilize a centralized server system have drawbacks. More specifically, the need for all of the data to pass through a centralized server system can cause significant scalability problems. When tens of thousands or hundreds of thousands of remote devices are being monitored, the need for all of the data to pass through a centralized server system can negatively impact overall performance and user experience. Additionally, with larger numbers of remote devices, larger scales of data must pass through switching servers in the centralized server system and, as mentioned earlier, these switching servers are typical points of failure. Clustering of switching servers is often used to address this issue, but at the expense of a much more complex and expensive centralized server system.

Additionally, the existing solutions lack any flexibility for utilizing anything other than a centralized server system approach to provide the required audit trail and traceability on all activities that take place on remotely managed devices. As a result, auditing requirements currently have locked in the centralized server system approach as the only viable option to satisfy the demand for such accountability.

### SUMMARY

A method for auditing peer-to-peer communications in a remote device monitoring system in accordance with embodiments of the present invention includes establishing a peer-to-peer communication between at least two computing devices. An auditing system associated with the established peer-to-peer communication is identified and audit information about at least a portion of the established peer-to-peer communication is stored in the identified auditing system.

A computer readable medium having stored thereon instructions for auditing peer-to-peer communications in a remote device monitoring system includes establishing a peer-to-peer communication between at least two computing devices. An auditing system associated with the established peer-to-peer communication is identified and audit information about at least a portion of the established peer-to-peer communication is stored in the identified auditing system.

An audit system for peer-to-peer communications includes a communication system, an identification system, and a recording system. The communication system establishes a peer-to-peer communication between at least two computing devices. The identification system identifies a recording system associated with the established peer-to-peer communication. The recording system stores audit information about at least a portion of the established peer-to-peer communication.

The present invention provides a number of advantages including providing an effective, efficient, and easy to use method and system to audit peer-to-peer communications in a remote device monitoring system. The present invention enables the creation of an audit and traceability trail for all interactions between user computing systems, remote devices, and autonomous computer systems on a peer-to-peer remote device management, monitoring and diagnostics network.

### BRIEF DESCRIPTION OF THE DRAWINGS

FIG. 1 is a block diagram of a remote device monitoring system that logs audit information about a peer-to-peer communications in accordance with embodiments of the present invention;

FIG. 2 is a flowchart of a method for logging audit information about a peer-to-peer communication in the remote device monitoring system; and

FIGS. 3A and 3B are flowchart of another method for logging audit information about a peer-to-peer communication in the remote device monitoring system.

### DETAILED DESCRIPTION

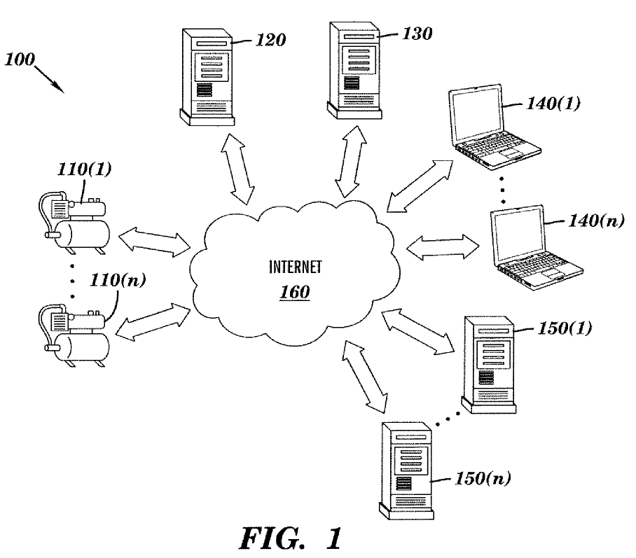

A remote device monitoring system 100 that logs audit information about a peer-to-peer communications in accordance with embodiments of the present invention is illustrated in FIG. 1. The remote device monitoring system 100 includes the monitored devices 110(1-n), a presence server system 120, an audit server system 130, user computing systems 140(1-n), management/monitoring server systems 150(1-n), and a communications network 160, although the system 100 can include other types and numbers of components, devices, systems and/or servers configured in other manners. The present invention provides a number of advantages including providing an effective, efficient, and easy to use method and system to audit peer-to-peer communications in a remote device monitoring system.

Referring more specifically to FIG. 1, the monitored devices 110(1-n) are located remotely from the user computing systems 140(1-n), although other types and numbers of components, devices, systems, and/or servers which are in other locations and proximities with could be used. By way of example only, the monitored devices 110(1-n) may comprise machines, production tools, hospital equipment, office equipment, monitoring devices, computer systems, or vehicles. Each of the monitored devices 110(1-n) autonomously and regularly initiates a connection to announce its presence to the presence server system 120, although other manners for identifying the presence of one or more of the devices 100(1-n) could be used.

Each of the monitored devices 110(1-n) also may monitor values of one or more parameters related to the monitored devices 110(1-n), such as parameters relating to the operation of each of the monitored devices 110(1-n), although other numbers of the monitored devices 110(1-n) could monitor values for other numbers and types of parameters or other characteristics. By way of example only, if the monitored devices 110(1-n) comprise office equipment, the one or more parameters monitored for each of the monitored devices 110(1-n) could comprise monitoring a current level of consumables or an operating condition for the office equipment.

Further, each of the monitored devices 110(1-n) monitors for one or more fault or abnormal conditions related to the monitored devices 110(1-n), although one or more of the monitored devices 110(1-n) could monitor for other numbers and types of conditions. Each of the monitored devices 110(1-n) stores a threshold value associated with each of the parameters, although the threshold values could be stored at other locations or obtained in other manners, such as by user input. When one or more of the threshold values in one of the monitored devices 110(1-n) is surpassed, the one of the monitored devices 110(1-n) determines a fault or abnormal condition exists, although other manners for identifying a fault or abnormal condition could be used. When a fault condition is identified in one of the monitored devices 110(1-n), the one of the devices 100(1-n) autonomously initiates an instant message that is sent out to one or more of the user computing systems 140(1-n) stored in a buddy list with the one of the monitored devices 110(1-n), although other manners for initiating the instant message and identifying the one or more recipients of the message could be used. The format of the instant message initiated by the one of the monitored devices 110(1-n) is an XML message using the Extensible Messaging and Presence Protocol (XMPP) with embedded SOAP encoding so that it invokes a instant messaging web service at the one or more user computing systems 140(1-n) designated as a recipient, although other types of messages and communication systems could be used.

Each of the monitored devices 110(1-n) includes a central processing unit (CPU) or processor, a memory, and an interface system which are coupled together by a bus or other link, although other numbers and types of each of the components and other configurations and locations for the components can be used. The processor in each of the monitored devices 110(1-n) executes a program of stored instructions for one or more aspects of the present invention as described herein, including for autonomously initiating a connection to announce the monitored devices 110(1-n) presence on the communication system 160, monitoring values for one or more parameters related to the monitored devices 110(1-n), and monitoring for one or more fault or abnormal conditions related to the monitored devices 110(1-n). The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The interface system in each of the monitored devices 110(1-n) is used to operatively couple and communicate between the monitored devices 110(1-n) and the presence server system 120, the audit server system 130, the user computing systems 140(1-n), and the management/monitoring server systems 150(1-n), although other numbers and types of connections to other devices, systems, and servers could be used.

The presence server system 120 is responsible for monitoring what monitored devices 110(1-n) and user computing systems 140(1-n) are currently online/offline and delivering an indication of such through an instant message style client running on one of the user computing systems 140(1-n), although other manners for monitoring the status of the monitored devices 110(1-n) and user computing systems 140(1-n) could be used. The presence server system 120 also creates and maintains connection and contact information to enable monitored devices 110(1-n) and user computing systems 140(1-n) to communicate, although this connection and contact information can be created and maintained in other manners. The presence server system 120 enables the establishment of direct connections between the monitored devices 110(1-n) and the user computing systems 140(1-n) or the management/monitoring server systems 150(1-n) from behind typical intranet security measures, including firewalls, Internet proxies and NATs, using well known techniques such as “Simple Traversal of UDP (User Datagram Protocol) through NATs (Network Address Translators)” (STUN) and Traversal Using Relay NAT (TURN). These connections established by the presence server system 120 can be transient, for example to deliver a short instant message style message, or long-term, for example to allow for file sharing, remote desktop sessions, or tunneling remote diagnostics.

The presence server system 120 includes a central processing unit (CPU) or processor, a memory, and an interface system which are coupled together by a bus or other link, although other numbers and types of each of the components and other configurations and locations for the components can be used. The processor in the presence server system 120 executes a program of stored instructions for one or more aspects of the present invention as described herein, including monitoring what monitored devices 110(1-n) and user computing systems 140(1-n) are currently online/offline and delivering an indication of such and creating and maintaining connection and contact information to enable monitored devices 110(1-n) and user computing systems 140(1-n) to communicate. The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used. The interface system in the presence server system 120 is used to operatively couple and communicate between the presence server system 120 and the monitored devices 110(1-n), the audit server system 130, the user computing systems 140(1-n), and the management/monitoring server systems 150(1-n), although other numbers and types of connections to other devices, systems, and servers could be used.

The audit server system 130 records a log of all activities that take place between one or more of the monitored devices 110(1-n) and one or more of the user computing systems 140(1-n) or one or more of the management/monitoring server systems 150(1-n), although other types and amounts of information could be recorded by the audit server system 130. By way of example only, this information can comprise information on: the initiation of the peer-to-peer communication; the completion of the peer-to-peer communication; the identity of the devices and/or systems in the established peer-to-peer communication; the device or system that initiated the establishment of the peer-to-peer communication; the request or requests made during the established peer-to-peer communication; the result or results during the established peer-to-peer communication; and the timestamp for the established peer-to-peer communication.

The audit server system 130 includes a central processing unit (CPU) or processor, a memory, and an interface system which are coupled together by a bus or other link, although other numbers and types of each of the components and other configurations and locations for the components can be used. The processor in the audit server system 130 executes a program of stored instructions for one or more aspects of the present invention as described herein, including recording a log of all activities that take place between one or more of the monitored devices 110(1-n) and one or more of the user computing systems 140(1-n). The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The interface system in the audit server system 130 is used to operatively couple and communicate between the audit server system 130 and the monitored devices 110(1-n), the presence server system 120, the user computing systems 140(1-n), and the management/monitoring server systems 150(1-n), although other numbers and types of connections to other devices, systems, and servers could be used.

Each of the user computing systems 140(1-n) enables a user or operator to establish a peer-to-peer communication with one or more of the monitored devices 110(1-n) to be notified of a fault or abnormal condition, request and receive values for one or more parameters at one or more of the monitored devices 110(1-n), and run and obtain information from one or more diagnostics executed at one or more of the monitored devices 110(1), although the user computing systems 140(1-n) could be used by an operator for other types and numbers of functions.

Each of the user computing systems 140(1-n) includes a central processing unit (CPU) or processor, a memory, an interface system, a user input system, and a display system which are coupled together by a bus or other link, although each of the user computing systems 140(1-n) can comprise other numbers and types of components and systems in other configurations. The processor in each of the user computing systems 140(1-n) executes a program of stored instructions for one or more aspects of the present invention as described and illustrated herein, including receiving notification of a fault or abnormal condition, requesting and receiving values for one or more parameters at one or more of the monitored devices 110(1-n), and running and obtaining information from one or more diagnostics executed at one or more of the monitored devices 110(1), although the processor could execute other types of programmed instructions. The memory in each of the user computing systems 140(1-n) stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one of the processor, can be used for the memory. The interface system in each of the user computing systems 140(1-n) is used to operatively couple and communicate between each of the user computing systems 140(1-n) and the monitored devices 110(1-n), the presence server system 120, the audit server system 130, and the management/monitoring server systems 150(1-n), although other numbers and types of connections to other devices, systems, and servers could be used.

The user input device in each of the user computing systems 140(1-n) is used to input selections, such as which of the monitored devices 110(1-n) are being monitored, managed, or diagnosed, which parameters to check, and which diagnostics to run on which of the monitored devices 110(1-n), although other types of data could be input. The user input device comprises a computer keyboard and a computer mouse, although other types and numbers of user input devices can be used. The display system in each of the user computing systems 140(1-n) is used to show data and information to the user, such as a detected fault or abnormal condition at one or more of the monitored devices 110(1-n), values for one or more selected parameters at one or more of the monitored devices 110(1-n), or data from diagnostics run at one or more of the monitored devices 110(1-n), although other types of data and information could be displayed and other manners of providing the information can be used. The display system comprises a computer display screen, such as a CRT or LCD screen by way of example only, although other types and numbers of displays could be used, such as a printer.

The optional management/monitoring server systems 150(1-n) provides a twenty-four hour and seven day a week monitoring service that automatically establish a peer-to-peer communication with one or more of the monitored devices 110(1-n) and request certain values for one or more parameters or run and obtain information from one or more diagnostics at one or more of the monitored devices 110(1-n), although the management/monitoring server systems 150(1-n) could perform other types and numbers of functions. Once the communication is completed, the management/monitoring server systems 150(1-n) would close the peer-to-peer communication. Additionally, the one of the management/monitoring server systems 150(1-n) could perform a periodic analysis on the obtained information returned from the one of the monitored devices 110(1-n) and based on this historical information make predictions, such as failure events or maintenance times. As another example, one of the management/monitoring systems 150(1-n) could be a Customer Relationship Management (CRM) system that automatically creates a trouble ticket upon receiving an alert notification from one or more of the monitored devices 110(1-n).

The management/monitoring server systems 150(1-n) includes a central processing unit (CPU) or processor, a memory, and an interface system which are coupled together by a bus or other link, although other numbers and types of each of the components and other configurations and locations for the components can be used. The processor in the management/monitoring server systems 150(1-n) executes a program of stored instructions for one or more aspects of the present invention as described herein, including automatically establishing a peer-to-peer communication with one or more of the monitored devices 110(1-n) and requesting certain values for one or more parameters or running and obtaining information from one or more diagnostics at one or more of the monitored devices 110(1-n). The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The interface system in the management/monitoring server systems 150(1-n) is used to operatively couple and communicate between the management/monitoring server systems 150(1-n) and the monitored devices 110(1-n), the presence server system 120, the audit server system 130, and the user computing systems 140(1-n), although other numbers and types of connections to other devices, systems, and servers could be used.

The communications network 160 comprises the Internet, although other types and numbers of communication systems, such as a direct connection, a local area network, a wide area network, modems and phone lines, e-mails, and/or wireless communication technology each having their own communications protocols, in other configurations could be used. In this particular embodiment, the communications network 160 uses industry-standard protocols including XMPP, XML, and HTTP, although other types of communications protocols and techniques such as Representational State Transfer (REST) or SOAP could be used.

Although an example of embodiments of the monitored devices 110(1-n), the presence server system 120, the audit server system 130, the user computing systems 140(1-n), and the management/monitoring server systems 150(1-n) are described and illustrated herein, each could be implemented on any suitable device, system, or server. It is to be understood that the devices, systems, and servers of the exemplary embodiments are for exemplary purposes, as many variations of the specific hardware and software used to implement the exemplary embodiments are possible, as will be appreciated by those skilled in the relevant art(s).

Furthermore, each of the devices, systems, and servers of the present invention may be conveniently implemented using one or more general purpose computer systems, microprocessors, digital signal processors, microcontrollers, and the like, programmed according to the teachings of the present invention as described and illustrated herein, as will be appreciated by those skilled in the computer and software arts.

In addition, two or more computing devices, systems, or servers can be substituted for any one of the devices, systems, or servers in any embodiment of the present invention. Accordingly, principles and advantages of distributed processing, such as redundancy, replication, and the like, also can be implemented, as desired, to increase the robustness and performance the devices and systems of the exemplary embodiments. The present invention also may be implemented on one or more of any devices, systems or servers that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention also may be embodied as a computer readable medium having instructions stored thereon for predictive capacity planning as described herein, which when executed by a processor, cause the processor to carry out the steps necessary to implement the methods of the present invention as described and illustrated herein.

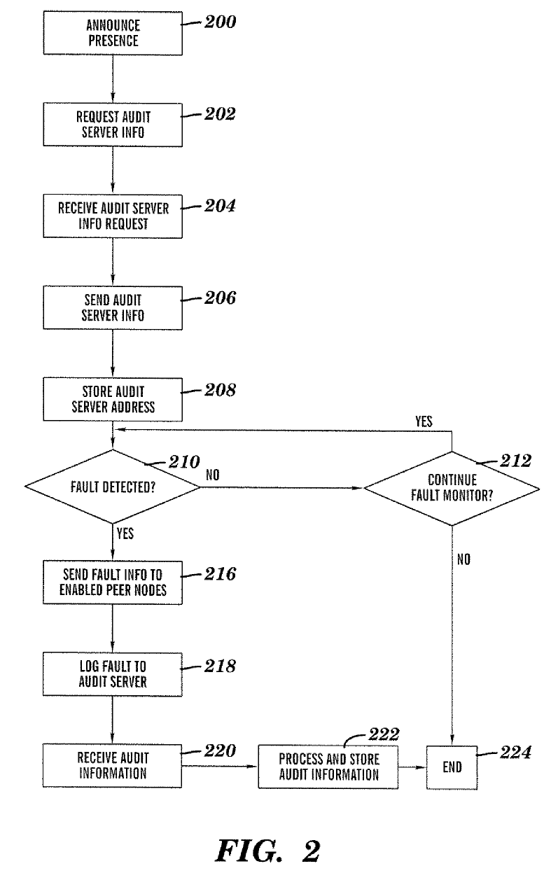

An example of a method for logging audit information about a peer-to-peer communication in the remote device monitoring system in accordance with embodiments of the present invention will now be described with reference to FIGS. 1-2. In this particular example at step 200, when the monitored device 110(1) goes online it autonomously initiates a connection to announce its presence to the presence server system 120, although other manners for identifying the presence of the monitored device 110(1) could be used. While the monitored device 110(1) remains online, the monitored device 110(1) maintains its connection or autonomously initiates a connection to announce its continued presence to the presence server system 120.

In this particular example, the presence server system 120 creates and maintains the necessary connection and contact information required for the monitored device 110(1) and user computing system 140(1) to communicate, although this connection and contact information can be created and maintained in other manners and for other numbers and types of systems and devices. The presence server system 120 enables the establishment of direct connections between the monitored device 110(1) and the user computing systems 140(1) in this example from behind typical intranet security measures, including firewalls, Internet proxies and NATs, using well known techniques such as “Simple Traversal of UDP (User Datagram Protocol) through NATs (Network Address Translators)” (STUN) and Traversal Using Relay NAT (TURN). These connections established by the presence server system 120 can be transient, for example to deliver a short instant message style message, or long-term, for example to allow for file sharing, remote desktop sessions, or tunneling remote diagnostics.

In step 202, the monitored device 110(1) also sends a message to the presence server system 120 requesting information about the audit server system 130, although other manners for obtaining information about the audit server system 130 can be used. In this example, the information requested includes the address of the audit server system 130 and any specific Uniform Resource Locator (URL) that may be used to send and log audit information about peer-to-peer communications with the monitored device 110(1) to the audit server system 130, although other types and amounts of information can be requested.

At step 204, the presence server system 120 receives and processes the request from the monitored device 110(1) for information about the audit server system 130. At step 206, the presence server system 120 responds back to the monitored device 110(1) with the requested information about the audit server system 130. At step, 208, the monitored device 110(1) stores the requested information from the presence server system 120 about the audit server system 130.

At step 210, the monitored device 110(1) determines if a fault or other abnormal condition related to the monitored device 110(1) has occurred based on the monitored values, although the monitored device 110(1-n) could monitor for other numbers and types of conditions. In this particular embodiment, the monitored device 110(1) monitor values of parameters related to the monitored device 110(1), such as parameters relating to the operation of the monitored device 110(1), although values of other types and numbers of parameters or other characteristics could be monitored. Additionally, the monitored device 110(1) stores a threshold value associated with each of the parameters, although the threshold values could be stored at other locations or obtained in other manners, such as by user input. When one or more of the threshold values in the monitored device 110(1) is surpassed, the monitored device 110(1) determines a fault or abnormal condition exists, although other manners for identifying a fault or abnormal condition could be used.

If in step 210, the monitored device 110(1) determines a fault or other abnormal condition has not occurred, then the No branch is taken to step 212. In step 212, the monitored device 110(1) determines whether to continue to monitor fault or other abnormal condition. If the monitored device 110(1) determines to continue to monitor for a fault or other abnormal condition, then the Yes branch is taken back to step 210. If the monitored device 110(1) determines not to continue to monitor for a fault or other abnormal condition, then the No branch is taken back to step 214 where this method ends.

If in step 210 the monitored device 110(1) determines a fault or other abnormal condition has occurred, then the Yes branch is taken to step 216. At step 216, the monitored device 110(1) examines its buddy list, which in this particular example comprises user computing system 140(1), and autonomously initiates an instant message that is sent out to the user computing system 140(1) about the detected fault or other abnormal condition, although other numbers and types of systems could receive the information and other manners for initiating and sending the information could be used. In this example, the format of the instant message initiated by the monitored devices 110(1) is an XML message with embedded SOAP encoding so that it invokes an instant messaging web service at the user computing system 140(1) designated as the recipient from the buddy list, although other types of messages and communication systems could be used.

At step 218, the monitored device 110(1) also creates and sends an instant message with audit information about the current peer-to-peer communication to the audit server system 130, although other types and numbers of messages can be sent to other types and numbers of systems and devices. In this example, the format of the instant message initiated by the monitored device 110(1) is an XML message with embedded SOAP encoding so that it invokes a instant messaging web service at the audit server system 130 designated as a recipient, although other types of messages and communication systems could be used

At step 220, the audit server system 130 receives the logging service request from the monitored device 110(1) with the audit information. At step 222, the audit server system 130 processes and stores the received audit information. Again by way of example only, this information can comprise information on: the initiation of the peer-to-peer communication; the completion of the peer-to-peer communication; the identity of the devices and/or systems in the established peer-to-peer communication; the device or system that initiated the establishment of the peer-to-peer communication; the request or request made during the established peer-to-peer communication; the result or results during the established peer-to-peer communication; and the timestamp for the established peer-to-peer communication. In response to a request, this stored audit information at the audit server system 130 can be retrieved from storage and displayed, although other types and numbers of operations can be performed on the stored audit information, such as transmitting it to another offsite storage system or using the stored audit information to determine if one or more diagnostics need to be executed on the monitored device 110(1). Next, at step 214 this method ends.

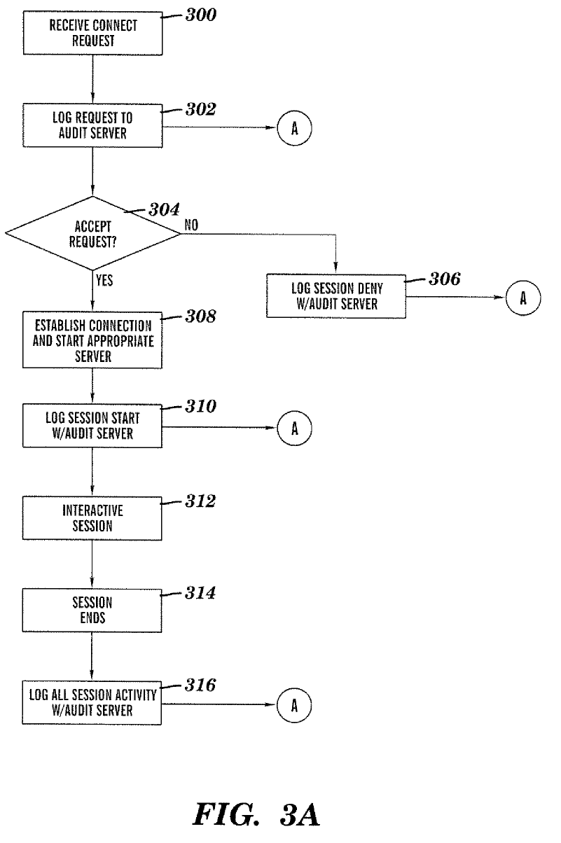

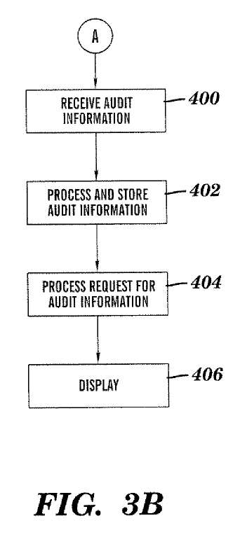

Another method for logging audit information about a peer-to-peer communication in the remote device monitoring system in accordance with other embodiments of the present invention will now be described with reference to FIGS. 1, 3A, and 3B. Referring more specifically to FIG. 3A, in this particular example at step 300, the monitored device 110(1) receives a request to establish a direct peer-to-peer communication from the user computing system 140(1), although other types and numbers of systems and devices could try and establish a peer-to-peer communication.

At step 302, the monitored device 110(1) creates and sends an instant message with audit information about the request from the user computing system 140(1) to initiate a peer-to-peer communication to the audit server system 130, although other types and numbers of messages can be sent to other types and numbers of systems and devices. In this example, the format of this instant message initiated by the monitored device 110(1) is an XML message with embedded SOAP encoding so that it invokes a instant messaging web service at the audit server system 130 designated as a recipient, although other types of messages and communication systems could be used

Referring to FIG. 3B, at step 400, the audit server system 130 receives the logging service request from the monitored device 110(1) with the audit information. At step 402, the audit server system 130 processes and stores the received audit information. Again by way of example only, this information can comprise information on: the initiation of the peer-to-peer communication; the completion of the peer-to-peer communication; the identity of the devices and/or systems in the established peer-to-peer communication; the device or system that initiated the establishment of the peer-to-peer communication; the request or request made during the established peer-to-peer communication; the result or results during the established peer-to-peer communication; and the timestamp for the established peer-to-peer communication.

At step 404, the audit server system 130 processes a request from the user computing system 140(1) to retrieve the stored audit information on monitored device 110(1) for display on the user computing system 140(1), although other types and numbers of systems and devices could make the request and other operations can be performed on the stored audit information. At step 406, the user computing system 140(1) receives and displays on a display device the requested audit information on the monitored device 110(1).

Referring back to FIG. 3A, at step 304 the monitored device 110(1) determines if the user computing system 140(1) that made the request has the appropriate permission to establish this type of direct peer-to-peer communication. If in step 304 the user computing system 140(1) that made the request does not have the appropriate permission to establish this type of direct peer-to-peer communication, then the No branch is taken to step 306. At step 306, the monitored device 110(1) creates and sends an instant message with audit information about the denial of the request to initiate a peer-to-peer communication from the user computing system 140(1) to the audit server system 130, although other types and numbers of messages can be sent to other types and numbers of systems and devices. Next, the method proceeds to steps 400-406 in FIG. 3B in the manner described above and then since a peer-to-peer communication was not established, then in this scenario this method ends.

Referring back to FIG. 3A, if in step 304 the user computing system 140(1) that made the request does have the appropriate permission to establish this type of direct peer-to-peer communication, then the Yes branch is taken to step 308. In this particular example at step 308, a direct peer-to-peer communication between the user computing system 140(1) and the monitored device 110(1) is established, although other types and numbers of connections between other types and numbers of systems and devices could be established.

At step 310, the monitored device 110(1) creates and sends an instant message with audit information about the establishment of the peer-to-peer communication between the monitored device 110(1) and the user computing system 140(1), although other types and numbers of messages can be sent to other types and numbers of systems and devices. Next, the method proceeds to steps 400-406 in FIG. 3B in the manner described above.

Meanwhile referring back to FIG. 3A, at step 312 the monitored device 110(1) tracks for auditing purposes the activity during the peer-to-peer communications. By way of example, the monitored device 110(1) can track one or more diagnostics executed at one or more of the monitored devices 110(1) in response to a request to do so by the user computing system 140(1), although other types and numbers of activities and other communications could be tracked for auditing purposes. At step 314, once this interactive peer-to-peer communication between the user computing system 140(1) and the monitored device 110(1) has been completed, then the peer-to-peer communication is terminated.

At step 316, the monitored device 110(1) creates and sends an instant message with audit information about the termination of the peer-to-peer communication between the monitored device 110(1) and the user computing system 140(1), although other types and numbers of messages can be sent to other types and numbers of systems and devices. Next, the method proceeds to steps 400-406 in FIG. 3B in the manner described above.

Accordingly, as illustrated and described herein the present invention provides an effective mechanism for auditing a peer-to-peer network that is used for applications, such as remote monitoring and diagnostics of field equipment. The system not only audits the initiation and completion of peer-to-peer communication between network nodes, such as monitored devices 110(1)-110(n) and user computing systems 140(1)-140(n), but also provides contextual auditing of the interactions between the monitored devices 110(1)-110(n) and user computing systems 140(1)-140(n) and other activities during the actual peer-to-peer communication session.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for auditing peer-to-peer communications in a remote device monitoring system, the method comprising:
establishing a peer-to-peer communication between at least two computing devices;
identifying an auditing system associated with the established peer-to-peer communication; and
storing audit information about at least a portion of the established peer-to-peer communication in the identified auditing system.

2. The method as set forth in claim 1 wherein the establishing a peer-to-peer communication between at least two computing devices further comprises establishing the peer-to-peer communication upon detection of at least one condition at one of the at least two computing devices.

3. The method as set forth in claim 1 wherein the at least one condition is at least one of a fault and an abnormal reading.

4. The method as set forth in claim 1 wherein the establishing the peer-to-peer communication between at least two computing devices further comprises:
reviewing a request to establish the peer-to-peer communication based on at least one criteria; and
establishing the peer-to-peer communication when the reviewed requests satisfies the at least one criteria.

5. The method as set forth in claim 1 wherein the stored audit information comprises at least one of information on an initiation of the peer-to-peer communication and a completion of the peer-to-peer communication.

6. The method as set forth in claim 1 wherein the stored audit information comprises information on at least a portion of activity during the peer-to-peer communication.

7. The method as set forth in claim 6 wherein the stored audit information comprises at least one of information identifying the at least two computing devices in the established peer-to-peer communication, the one of the at least two computing devices that initiated the establishment of the peer-to-peer communication at least one request made during the established peer-to-peer communication, at least one result during the established peer-to-peer communication, and a timestamp for the established peer-to-peer communication.

8. A computer readable medium having stored thereon instructions for auditing peer-to-peer communications in a remote device monitoring system comprising machine executable code which when executed by at least one processor, causes the processor to perform steps comprising:
establishing a peer-to-peer communication between at least two computing devices;
identifying an auditing system associated with the established peer-to-peer communication; and
storing audit information about at least a portion of the established peer-to-peer communication in the identified auditing system.

9. The medium as set forth in claim 8 wherein the establishing a peer-to-peer communication between at least two computing devices further comprises establishing the peer-to-peer communication upon detection of at least one condition at one of the at least two computing devices.

10. The medium as set forth in claim 8 wherein the at least one condition is at least one of a fault and an abnormal reading.

11. The medium as set forth in claim 8 wherein the establishing the peer-to-peer communication between at least two computing devices further comprises:
reviewing a request to establish the peer-to-peer communication based on at least one criteria; and
establishing the peer-to-peer communication when the reviewed requests satisfies the at least one criteria.

12. The medium as set forth in claim 8 wherein the stored audit information comprises at least one of information on an initiation of the peer-to-peer communication and a completion of the peer-to-peer communication.

13. The medium as set forth in claim 8 wherein the stored audit information comprises information on at least a portion of activity during the peer-to-peer communication.

14. The medium as set forth in claim 13 wherein the stored audit information comprises at least one of information identifying the at least two computing devices in the established peer-to-peer communication, the one of the at least two computing devices that initiated the establishment of the peer-to-peer communication at least one request made during the established peer-to-peer communication, at least one result during the established peer-to-peer communication, and a timestamp for the established peer-to-peer communication.

15. An audit system for peer-to-peer communications, the system comprising:
a communication system which establishes a peer-to-peer communication between at least two computing devices;
an identification system that identifies a recording system associated with the established peer-to-peer communication; and
the recording system stores audit information about at least a portion of the established peer-to-peer communication.

16. The system as set forth in claim 15 wherein the communication system establishes the peer-to-peer communication upon detection of at least one condition at one of the at least two computing devices.

17. The system as set forth in claim 15 wherein the at least one condition is at least one of a fault and an abnormal reading.

18. The system as set forth in claim 15 wherein the communication system processes a request to establish the peer-to-peer communication based on at least one criteria and establishes the peer-to-peer communication when the reviewed requests satisfies the at least one criteria.

19. The system as set forth in claim 15 wherein the stored audit information comprises at least one of information on an initiation of the peer-to-peer communication and a completion of the peer-to-peer communication.

20. The system as set forth in claim 15 wherein the stored audit information comprises information on at least a portion of activity during the peer-to-peer communication.

21. The system as set forth in claim 20 wherein the stored audit information comprises at least one of information identifying the at least two computing devices in the established peer-to-peer communication, the one of the at least two computing devices that initiated the establishment of the peer-to-peer communication at least one request made during the established peer-to-peer communication, at least one result during the established peer-to-peer communication, and a timestamp for the established peer-to-peer communication.
